(19) United States
(12) Patent Application Publication
(10) Pub. No.: US 2023/0378992 A1
(43) Pub. Date: Nov. 23, 2023

(54) WATERPROOF PROTECTIVE CASE FOR ELECTRONIC DEVICE

(71) Applicant: SHENZHEN YISE TECHNOLOGY CO., LTD., Shenzhen (CN)

(72) Inventor: LI XIN DENG, Shenzhen (CN)

(21) Appl. No.: 17/964,062

(22) Filed: Oct. 12, 2022

(30) Foreign Application Priority Data
May 21, 2022 (CN) 202221239623.0

(51) Int. Cl. H04B 1/3888

(52) U.S. Cl. CPC H04B 1/3888

(57) ABSTRACT

A waterproof protective case for an electronic device includes a top cover, a middle frame, and a bottom cover. The middle frame is arranged between the top cover and the bottom cover. Buckle hooks are connected with the top cover and/or the bottom cover. Buckles corresponding to positions of the buckle hooks are arranged on the bottom cover and/or the top cover. The buckle hooks are snapped on the buckles to gaplessly limit the middle frame between the top cover and the bottom cover. The top cover, the middle frame, and the bottom cover are bucked together to from a pressure-tight chamber.

### TECHNICAL FIELD

The present disclosure relates to a technical field of protective cases, and in particular to a waterproof protective case for an electronic device.

### BACKGROUND

A protective case is a product sleeved on an outer side of an electronic device to protect the electronic device. With an increase of underwater activities, more and more people need to use electronic devices underwater, such as taking pictures with the electronic devices. Therefore, a waterproof protective case is created. Generally, a conventional waterproof protective case is fastened through screws, making it hard to disassemble or assemble the electronic device with the conventional waterproof protective case.

### SUMMARY

In view of this, it is necessary to provide a waterproof protective case for an electronic device to conveniently fasten various components of the waterproof protective case to form a pressure-tight chamber.

The present disclosure provides a waterproof protective case for an electronic device. The waterproof protective case for the electronic device comprises a top cover, a middle frame, and a bottom cover. The middle frame is arranged between the top cover and the bottom cover. Buckle hooks are connected with the top cover and/or the bottom cover. Buckles corresponding to positions of the buckle hooks are arranged on the bottom cover and/or the top cover. The buckle hooks are snapped on the buckles to limit the middle frame between the top cover and the bottom cover.

Furthermore, the middle frame is made of a sealing material.

Furthermore, the buckle hooks are hinged with the top cover or the bottom cover.

Furthermore, inserting grooves are provided on one side of the middle frame facing the top cover. The top cover comprises connecting portions. Each of the connecting portions is inserted into a corresponding inserting groove of the inserting grooves. The buckle hooks are hinged with the connecting portions; and/or the inserting grooves are provided on one side of the middle frame facing the bottom cover. The bottom cover comprises the connecting portions. Each of the connecting portions is inserted into the corresponding inserting groove of the inserting grooves. The buckle hooks are hinged with the connecting portions.

Furthermore, a surface of the middle frame contacting the bottom cover defines a first area and a second area. A surface of the bottom cover contacting the middle frame defines a third area and a fourth area. The first area and the third area are flat surfaces. The first area and the third area are perpendicular to fastening forces of the buckle hooks. The second area and the fourth area are inclined surfaces with respect to the first area and the third area. When the buckle hooks are snapped on the buckles, the first area contacts the third area and the second area contacts the fourth area.

Furthermore, the second area is the inclined surface inclined toward an inner side of the bottom cover. The second area protrudes from the first area.

Furthermore, a surface of the middle frame contacting the top cover defines a fifth area and a sixth area. A surface of the top cover contacting the middle frame defines a seventh area and an eighth area. The fifth area and the seventh area are flat surfaces. The fifth area and the seventh area are perpendicular to fastening forces of the buckle hooks. The sixth area and the eighth area are inclined surfaces with respect to the fifth area and the seventh area. When the buckle hooks are snapped on the buckles, the fifth area contacts the seventh area and the sixth area contacts the eighth area.

Furthermore, the sixth area is the inclined surface inclined toward an inner side of the top cover. The sixth area protrudes from the fifth area.

Furthermore, an outer side of the middle frame recesses to form first accommodating grooves. An outer side of the top cover and/or an outer side of the bottom cover recesses to form second accommodating grooves. Each of the buckles is formed in a corresponding second accommodating groove of the second accommodating grooves. When the buckle hooks are snapped on the buckles, each of the buckle hooks is accommodated in a corresponding first accommodating groove of the first accommodating grooves and a corresponding second accommodating groove of the second accommodating grooves.

Compared with the prior art, the waterproof protective case comprises the top cover, the middle frame, and the bottom cover. At least a position of the middle frame contacting the top cover and a position of the middle frame contacting the bottom cover are made of the sealing material. The buckle hooks are snapped on the buckles, so the middle frame is gaplessly limited between the top cover and the bottom cover. The sealing material of the middle frame realizes a sealing effect of the waterproof protective case, so the present disclosure is waterproof. The top cover, the middle frame, and the bottom cover are bucked together to from a pressure-tight chamber, making it convenient to disassemble or assemble the electronic device with the waterproof protective case.

### BRIEF DESCRIPTION OF DRAWINGS

FIG. 1 is a schematic diagram of a waterproof protective case of the present disclosure.

FIG. 2 is an exploded schematic diagram of the waterproof protective case shown in FIG. 1.

FIG. 3 is a cross-sectional schematic diagram of the waterproof protective case of the present disclosure.

FIG. 4 is a cross-sectional schematic diagram of the waterproof protective case taken along a position where inserting grooves are located.

FIG. 5 is an enlarged view taken from area A shown in FIG. 3.

FIG. 6 is an enlarged view taken from area B shown in FIG. 4.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure. It is understood that the drawings are only provided for reference and illustration, and are not used to limit the present disclosure. The connection relationship shown in the drawings is only for the convenience of clear description, and does not intend to limit the connection mode.

It should be noted that when a component is considered to be “connected” to another component, it can be directly connected to another component, or there may be a centered component at the same time. Unless otherwise defined, all technical and scientific terms used herein have the same meaning as commonly understood by those skilled in the art of the present disclosure. It should be noted in the description of the present disclosure that, unless otherwise regulated and defined, terms such as “installation”, “bonded”, and “connection” shall be understood in broad sense, and for example, may refer to fixed connection or detachable connection or integral connection; may refer to mechanical connection or electrical connection; and may refer to direct connection or indirect connection through an intermediate medium or inner communication of two elements. For those of ordinary skill in the art, the meanings of the above terms in the present disclosure may be understood according to concrete conditions.

In addition, it should be noted that in the description of the present disclosure terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present disclosure and the simplification of the description rather than to indicate or imply that the indicated device or element must have a specific direction or constructed and operated in a specific direction, and therefore, shall not be understood as a limitation to the present disclosure. In addition, terms such as “first”, “second”, and “third” are only used for the purpose of description, rather than being understood to indicate or imply relative importance.

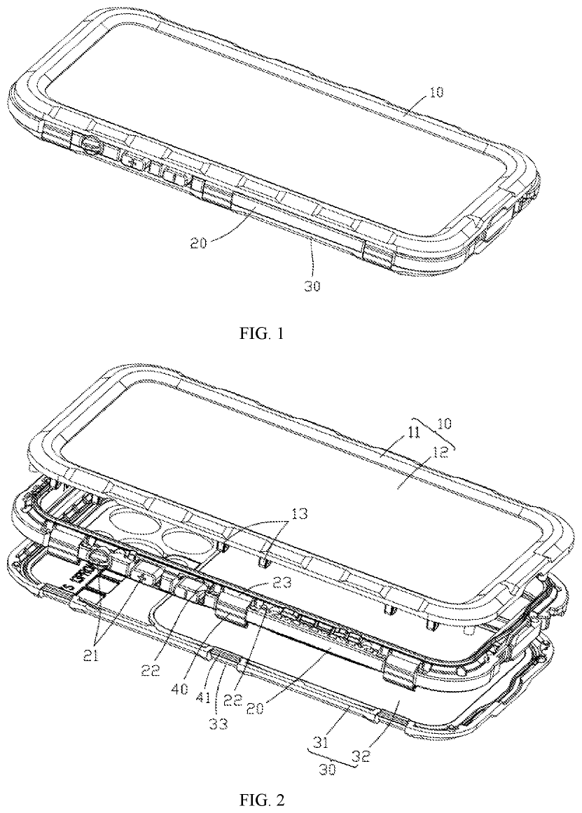

In one specific embodiment, the present disclosure provides a waterproof protective case for an electronic device. As shown in FIGS. 1 and 2, the waterproof protective case for the electronic device comprises a top cover 10, a middle frame 20, and a bottom cover 30. The middle frame 20 is arranged between the top cover 10 and the bottom cover 30. In the embodiment, at least a position of the middle frame 20 contacting the top cover 10 and a position of the middle frame 20 contacting the bottom cover 30 are made of a sealing material.

In the embodiment, the top cover 10 comprises a top frame 11 and a top panel 12, and the bottom cover 30 comprises a bottom frame 31 and a bottom plate 32. The top panel 12 is made of a transparent material so that a user can watch a screen of the electronic device through the top panel 12. The top frame 11 and the bottom frame 31 are made of hard materials (for example, metal or hard plastic). The middle frame 20 is made of a sealing material (for example, silicone or other flexible glue). A plurality of buttons 21 is arranged on the middle frame. The plurality of buttons 21 comprises sound adjusting buttons, a switch button, and other buttons, which is not limited thereto.

Buckle hooks 40 are connected with the top cover 10. Buckles 41 corresponding to positions of the buckle hooks 40 are arranged on the bottom cover 30. The buckle hooks 40 are snapped on the buckles 41 to gaplessly limit the middle frame 20 between the top cover 10 and the bottom cover 30. In other embodiments, the buckle hooks 40 are connected with the bottom cover 30 and the buckles 41 corresponding to positions of the buckle hooks 40 are arranged on the top cover 10, which is not limited thereto.

Specifically, as shown in FIGS. 2 and 3, the buckle hooks 40 are hinged with the top cover 10. So the buckle hooks 40 are non-detachable but rotatably connected to the top cover 10, which prevents the buckle hooks 40 from separating from the top cover 10. By rotating the buckle hooks 40, the buckle hooks 40 are disconnected with the buckles 41, so the bottom cover 30 is taken off and the electronic device is put into the waterproof protective case.

Two inserting grooves 22 spaced apart are provided on one side of the middle frame 20 facing the top cover 10. The top cover 10 comprises two connecting portions 13 spaced apart. Each of the connecting portions 13 is inserted into a corresponding inserting groove 22 of the inserting grooves, so the buckle hooks 40 are hinged with the connecting portions 13.

Alternatively, the inserting grooves 22 are provided on one side of the middle frame 20 facing the bottom cover 10. The bottom cover 30 comprises the connecting portions 13.

Each of the connecting portions 13 is inserted into the corresponding inserting groove 22 of the inserting grooves 22. The buckle hooks 40 are hinged with the connecting portions 13. Thus, the connecting portions are received in the inserting grooves 22 and the buckle hooks are hinged to the middle frame 20, preventing the buckle hooks 40 from hinging with the top frame 11, which reduces a thickness of the top cover 10.

An outer side of the middle frame 20 recesses to form first accommodating grooves 23. An outer side of the bottom cover 30 recesses to form second accommodating grooves 33. Each of the buckles 41 is formed in a corresponding second accommodating groove 33 of the second accommodating grooves 33. When the buckle hooks 40 are snapped on the buckles 41, each of the buckle hooks 40 is accommodated in a corresponding first accommodating groove 23 of the first accommodating grooves 23 and a corresponding second accommodating groove 33 of the second accommodating grooves 33. By such arrangements, an appearance of the waterproof protective case is smooth, making the waterproof protective case smooth to touch. Thus, the buckles 41 are hardly separated from the buckle hooks 40 due to unintended touch.

Similarly, in other embodiments, if the buckle hooks 40 are hinged with the bottom cover 30, then the inserting grooves 22 are provided on the one side of the middle frame 20 facing the bottom cover 30 and the connecting portions 13 are arranged on the bottom cover 30. Each of the connecting portions 13 is inserted into the corresponding inserting groove 22. A rotating shaft 401 of each of the buckle hooks is hinged with a corresponding connecting portion 13. In the embodiment, an outer side of the top cover 10 is recessed to form the second accommodating grooves 33.

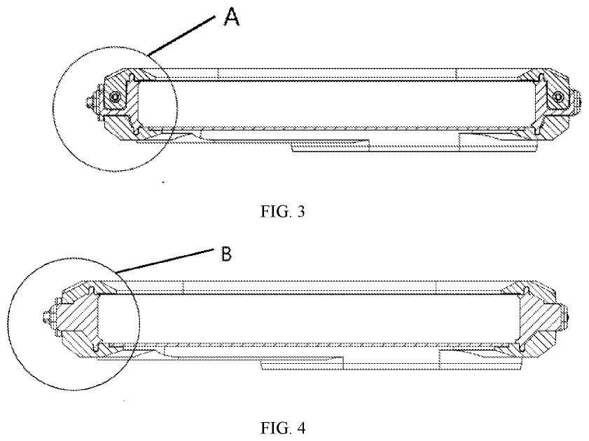

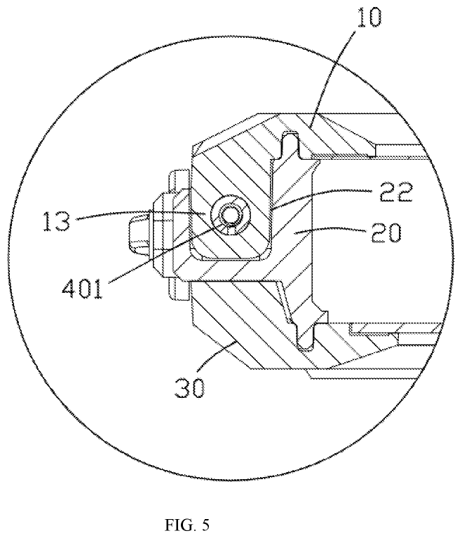

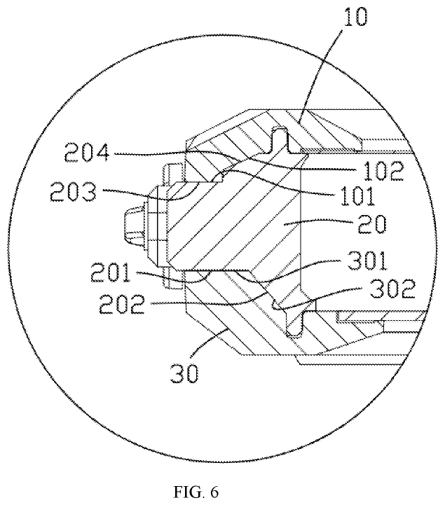

In one embodiment, as shown in FIG. 4, a surface of the middle frame 20 contacting the bottom cover defines a first area 201 and a second area 202. A surface of the bottom cover 30 contacting the middle frame defines a third area 301 and a fourth area 302. The first area 201 and the third area 301 are flat surfaces. The first area 201 and the third area 301 are perpendicular to fastening forces of the buckle hooks 40. The second area 202 and the fourth area 302 are inclined surfaces with respect to the first area 201 and the third area 301. When the buckle hooks 40 are snapped on the buckles 41, the first area 201 contacts the third area 301 and the second area 202 contacts the fourth area 302. By such arrangements, the first area 201 and the third area 301 are horizontally sealed (that is, the first area 201 and the third area 301 are sealed perpendicular to the fastening forces of the buckle hooks 40). The first area 201 and the third area 301 form a main sealing area. Because the second area 202 and the fourth area 302 are inclined surfaces, the fastening forces forms an acute angle with the second area 202 and the fourth area 302. Therefore, the second area 202 and the fourth area 302 also realize the sealing effect. However, the second area 202 and the fourth area 302 are inclined surfaces with respect to the first area 201 and the third area 301, a sealing area of the inclined surfaces is greater than a sealing area of the flat surfaces.

Furthermore, the second area 202 is the inclined surface inclined toward an inner side of the bottom cover 30 and the second area 202 protrudes from the first area 201, so the outer side of the middle frame 20 is thin and an inner side of the middle frame is thick. The outer side of the middle frame 20 confirms to sizes of the buttons 21 of the electronic device, and the inner side of the middle frame 20 confirms to a size of the electronic device.

Similarly, a surface of the middle frame 20 contacting the top cover 10 defines a fifth area 203 and a sixth area 204. A surface of the top cover 10 contacting the middle frame defines a seventh area 101 and an eighth area 102. The fifth area 203 and the seventh area 101 are flat surfaces. The fifth area 203 and the seventh area 101 are perpendicular to fastening forces of the buckle hooks 40. The sixth area 204 and the eighth area 102 are inclined surfaces with respect to the fifth area 203 and the seventh area 101. When the buckle hooks 40 are snapped on the buckles 41, the fifth area 203 contacts the seventh area 101 and the sixth area 204 contacts the eighth area 102.

Furthermore, the sixth area 204 is the inclined surface inclined toward an inner side of the top cover 10 and the sixth area 204 protrudes from the fifth area 203. Therefore, the outer side of the middle frame 20 is thin and the inner side of the middle frame is thick. The outer side of the middle frame 20 confirms to the sizes of the buttons 21 of the electronic device, and the inner side of the middle frame 20 confirms to the size of the electronic device.

In the specification and claims of the present disclosure, terms “include/comprise” and terms “have/contain” and their variants are used to designate existence of stated features, values, steps or components, but do not exclude the existence or addition of one or multiple other features, values, steps, components, or combinations thereof.

For clarity of explanation, some features of the present disclosure are described in different embodiments. However, these features can also be combined and described in a single embodiment. Moreover, some features of the present disclosure are only described in a single embodiment for the sake of brevity. However, these features can also be described in different embodiments separately or in any suitable combination.

Foregoing descriptions are only optional embodiments of the present disclosure and are not intended to limit the present disclosure. Any modification, equivalent replacement, or improvement within the technical scope of the present disclosure should be included in the protection scope of the present disclosure.

What is claimed is:

1. A waterproof protective case for an electronic device, comprising:
a top cover;
a middle frame; and
a bottom cover;
the middle frame is arranged between the top cover and the bottom cover; buckle hooks are connected with the top cover and/or the bottom cover; buckles corresponding to positions of the buckle hooks are arranged on the bottom cover and/or the top cover; the buckle hooks are snapped on the buckles to limit the middle frame between the top cover and the bottom cover.

2. The waterproof protective case for the electronic device according to claim 1, wherein the middle frame is made of a sealing material.

3. The waterproof protective case for the electronic device according to claim 1, wherein the buckle hooks are hinged with the top cover or the bottom cover.

4. The waterproof protective case for the electronic device according to claim 3, wherein inserting grooves are provided on one side of the middle frame facing the top cover; the top cover comprises connecting portions; each of the connecting portions is inserted into a corresponding inserting groove of the inserting grooves; the buckle hooks are hinged with the connecting portions; and/or
the inserting grooves are provided on one side of the middle frame facing the bottom cover; the bottom cover comprises the connecting portions; each of the connecting portions is inserted into the corresponding inserting groove of the inserting grooves; the buckle hooks are hinged with the connecting portions.

5. The waterproof protective case for the electronic device according to claim 1, wherein a surface of the middle frame contacting the bottom cover defines a first area and a second area; a surface of the bottom cover contacting the middle frame defines a third area and a fourth area; the first area and the third area are flat surfaces; the first area and the third area are perpendicular to fastening forces of the buckle hooks; the second area and the fourth area are inclined surfaces with respect to the first area and the third area; when the buckle hooks are snapped on the buckles, the first area contacts the third area and the second area contacts the fourth area.

6. The waterproof protective case for the electronic device according to claim 5, wherein the second area is the inclined surface inclined toward an inner side of the bottom cover; the second area protrudes from the first area.

7. The waterproof protective case for the electronic device according to claim 1, wherein a surface of the middle frame contacting the top cover defines a fifth area and a sixth area; a surface of the top cover contacting the middle frame defines a seventh area and an eighth area; the fifth area and the seventh area are flat surfaces; the fifth area and the seventh area are perpendicular to fastening forces of the buckle hooks; the sixth area and the eighth area are inclined surfaces with respect to the fifth area and the seventh area; when the buckle hooks are snapped on the buckles, the fifth area contacts the seventh area and the sixth area contacts the eighth area.

8. The waterproof protective case for the electronic device according to claim 7, wherein the sixth area is the inclined surface inclined toward an inner side of the top cover; the sixth area protrudes from the fifth area.

9. The waterproof protective case for the electronic device according to claim 1, wherein an outer side of the middle frame recesses to form first accommodating grooves; an outer side of the top cover and/or an outer side of the bottom cover recesses to form second accommodating grooves; each of the buckles is formed in a corresponding second accommodating groove of the second accommodating grooves; when the buckle hooks are snapped on the buckles, each of the buckle hooks is accommodated in a corresponding first accommodating groove of the first accommodating grooves and a corresponding second accommodating groove of the second accommodating grooves.
